(19) United States
(12) Patent Application Publication
(10) Pub. No.: US 2009/0306303 A1
(43) Pub. Date: Dec. 10, 2009

(54) CURABLE BASE-RESISTANT FLUOROELASTOMERS

(75) Inventor: Walter W. Schmiegel, Wilmington, DE (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(73) Assignee: DuPont Peformance Elastomers L.L.C., Wilmington, DE (US)

(21) Appl. No.: 12/472,749

(22) Filed: May 27, 2009

Related U.S. Application Data
(60) Provisional application No. 61/059,840, filed on Jun. 9, 2008.

(51) Int. Cl. C08L 27/12

(52) U.S. Cl. 525/326.3

(57) ABSTRACT

Compositions of fluoroelastomers containing copolymerized units of tetrafluoroethylene, propylene, optionally vinylidene fluoride, and a cure site monomer selected from the group consisting of i) trifluoroethylene, ii) 3,3,3-trifluoropropene-1, iii) 1,2,3,3,3-pentafluoropropylene, iv) 1,1,3,3,3-pentafluoropropylene, and v) 2,3,3,3-tetrafluoropropene are readily curable with polyhydroxy curatives and at least one vulcanization accelerator of formula R₁R₂R₃R₄NBF₄ wherein R₁, R₂, R₃, R₄ are the same or different C₁-C₁₂ alkyl groups.

### CROSS-REFERENCE TO RELATED APPLICATIONS

This application claims the benefit of U.S. Provisional Application No. 61/059,840 filed Jun. 9, 2008.

### FIELD OF THE INVENTION

This invention relates to polyhydroxy curable fluoroelastomer compositions having a rapid cure rate and low scorch wherein the fluoroelastomer comprises copolymerized units of tetrafluoroethylene, propylene, and a cure site monomer selected from the group consisting of i) trifluoroethylene, ii) 3,3,3-trifluoropropene-1, iii) 1,2,3,3,3-pentafluoropropylene, iv) 1,1,3,3,3-pentafluoropropylene, and v) 2,3,3,3-tetrafluoropropene and wherein at least one cure accelerator has a formula R₁R₂R₃R₄NBF₄ wherein R₁, R₂, R₃, R₄ are the same or different C₁-C₁₂ alkyl groups.

### BACKGROUND OF THE INVENTION

Fluoroelastomers made from copolymers of tetrafluoroethylene (TFE), propylene (P), and optionally vinylidene fluoride (VF₂) (i.e. TFE/P dipolymers or VF₂/TFE/P terpolymers) are often utilized in applications wherein resistance to alkaline fluids and other high pH chemicals is critical.

In order to fully develop physical properties such as tensile strength, elongation, and compression set, elastomers must be cured, i.e. vulcanized or crosslinked. In the case of fluoroelastomers, this is generally accomplished by mixing uncured polymer (i.e. fluoroelastomer gum) with a polyfunctional curing agent and heating the resultant mixture under pressure, thereby promoting chemical reaction of the curing agent with active sites along the polymer backbone or side chains. Interchain linkages produced as a result of these chemical reactions cause formation of a crosslinked polymer composition having a three-dimensional network structure. Commonly employed curing agents for fluoroelastomers include difunctional nucleophilic reactants, such as polyhydroxy compounds.

In many cases, polyhydroxy curing agent formulations are unsatisfactory when used to crosslink fluoroelastomers based on copolymers of TFE and P due to the lack of reactive sites on the copolymer. In such cases, tetrafluoroethylene and propylene can be copolymerized with one or more cure site monomers, e.g. 3,3,3-trifluoropropene, in order to improve the crosslinking reaction (U.S. Pat. No. 6,703,450 B2).

It can be difficult to optimize the cure characteristics of these polyhydroxy-curable fluoroelastomer compositions. Ideally the compositions should have minimal or no crosslinking prior to complete mixing and shaping (i.e. low scorch) and should then crosslink rapidly to a high state of cure. Too much crosslinking before complete mixing and shaping (i.e. high scorch) can make the compositions impossible to process. Too slow a cure rate after shaping, or too low a state of cure, can cause processes to be uneconomical and result in cured articles having poor tensile properties.

### SUMMARY OF THE INVENTION

It has been surprisingly found that polyhydroxy curable compositions of TFE/P type fluoroelastomers having a desirable balance of scorch safety, cure rate and state of cure can be formulated by employing at least one vulcanization accelerator of the formula R₁R₂R₃R₄NBF₄ wherein R₁, R₂, R₃, R₄ are the same or different C₁-C₁₂ alkyl groups. The resulting cured fluoroelastomer articles have excellent compression set resistance and tensile properties.

Accordingly, an aspect of this invention is a curable fluoroelastomer composition comprising:
A) a fluoroelastomer comprising copolymerized units of 45 to 80 weight percent tetrafluoroethylene; 10 to 40 weight percent propylene; and 0.1 to 10 mole percent of a cure site monomer selected from the group consisting of i) trifluoroethylene, ii) 3,3,3-trifluoropropene-1, iii) 1,2,3,3,3-pentafluoropropylene, iv) 1,1,3,3,3-pentafluoropropylene, and v) 2,3,3,3-tetrafluoropropene;
B) 0.1 to 20 parts by weight per 100 parts by weight fluoroelastomer of a polyhydroxy curing agent;
C) 0.5 to 30 parts by weight per 100 parts by weight fluoroelastomer of an acid acceptor; and
D) 0.1 to 10 parts by weight per 100 parts by weight fluoroelastomer of at least one vulcanization accelerator of formula R₁R₂R₃R₄NBF₄ wherein R₁, R₂, R₃, R₄ are the same or different C₁-C₁₂ alkyl groups.

### DETAILED DESCRIPTION OF THE INVENTION

Fluoroelastomers which may be employed in the curable 20 compositions of this invention include the copolymer of tetrafluoroethylene (TFE), propylene (P) and a cure site monomer selected from the group consisting of i) trifluoroethylene (TrFE), ii) 3,3,3-trifluoropropene-1 (TFP), iii) 1,2,3,3,3-pentafluoropropylene (1-HPFP) iv) 1,1,3,3,3-pentafluoropropylene (2-HPFP), and v) 2,3,3,3-tetrafluoropropene. Minor amounts (i.e. less than about 20 weight percent total) of other copolymerizable monomers may optionally be present in the copolymer fluoroelastomers of this invention. Examples of such monomers include, but are not limited to chlorotrifluoroethylene, vinyl fluoride, perfluoro(alkyl vinyl) ethers, perfluoro(alkoxy vinyl) ethers, perfluoro(alkoxyalkyl vinyl) ethers, perfluoroalkyl- or perfluoroalkoxy- alkenyl ethers (such as those disclosed in U.S. Pat. No. 5,891,965), ethylene, and isobutene.

Generally the fluoroelastomers used in the compositions of this invention contain 45 to 80 (preferably 50 to 78, most preferably 65 to 78) weight percent copolymerized units of tetrafluoroethylene, based on the total weight of the fluoroelastomer. Less TFE causes the polymerization to be slow, while more TFE causes the resulting polymer to be plastic, rather than elastomeric.

The fluoroelastomers employed in the compositions of this invention typically contain 10 to 40 (preferably 12 to 30, most preferably 15 to 25) weight percent copolymerized units of propylene, based on the total weight of the fluoroelastomer. Less propylene causes the polymer to become plastic, while more propylene causes the polymerization to become slow.

The fluoroelastomers used in the compositions of this invention also contain 0.1 to 10 (preferably 0.5 to 8, most preferably 1 to 6) mole percent (mol %) copolymerized units of a cure site monomer, based on total monomer units in the fluoroelastomer. The cure site monomer is selected from the group consisting of i) trifluoroethylene, ii) 3,3,3-trifluoropropene-1, iii) 1,2,3,3,3-pentafluoropropylene, iv) 1,1,3,3,3-pentafluoropropylene, and v) 2,3,3,3-tetrafluoropropene. The monomer 3,3,3-trifluoropropene-1 is especially preferred. A preferred fluoroelastomer comprises copolymerized units of tetrafluoroethylene, propylene, and 3,3,3-trifluoropropene-1.

It is believed that during the polyhydroxy curing process, some copolymerized units of cure site monomer, which are located adjacent to tetrafluoroethylene units in the fluoroelastomer polymer chain, dehydrofluorinate to form sites of unsaturation (i.e. C—C double bonds). These unsaturated sites are then available to react with polyhydroxy curatives to form crosslinks. Fluoroelastomers containing less than 0.1 mol % units of cure site units do not form a sufficient number of crosslinks to yield a cured product having desirable tensile properties for most end uses. Fluoroelastomers containing more than 10 mole percent cure site units are not desirable because the polymerization is slowed and there is a reduction in the fluoroelastomer's resistance to alkaline fluids and other high pH chemicals.

Optionally the fluoroelastomers employed in the compositions of this invention may further comprise bromine or iodine cure sites in the form of bromine- or iodine-containing cure site monomers such as CF₂═CFOCF₂CF₂CF₂OCF₂CF₂Br; 1-bromo-2,2-difluoroethylene; bromo-trifluoroethylene; 4-bromo-3,3,4,4-tetrafluorobutene-1 (BTFB); 4-bromo-1,1,2-trifluorobutene-1; 2-bromoperfluoro(ethyl vinyl) ether; 3-bromoperfluoro(propyl vinyl) ether; and 4-iodo-3,3,4,4-tetrafluorobutene-1. If an optional bromine or iodine containing cure site monomer is present in the fluoroelastomers employed in this invention, it is present in an amount no more than 2 mole percent, based on total monomer units in the fluoroelastomer.

Alternatively, optional bromine or iodine cure sites (2 mole percent or less) may be introduced onto the fluoroelastomer polymer chain ends by use of iodinated or brominated chain transfer agents such as methylene iodide or 1,4-diiodoperfluorobutane during polymerization. The presence of brominated or iodinated groups permits the fluoroelastomers of this invention to be cured by organic peroxides in addition to polyhydroxy curatives.

A particularly preferred fluoroelastomer comprises copolymerized units of tetrafluoroethylene, propylene, 3,3,3-trifluoropropene-1 and 4-bromo-3,3,4,4-tetrafluorobutene-1.

Preferably, the fluoroelastomers employed in this invention do not contain any copolymerized units of vinylidene fluoride. However, the fluoroelastomers may, optionally, contain up to 30 weight percent copolymerized units of vinylidene fluoride (VF₂), based on the total weight of the fluoroelastomer. If the fluoroelastomer does contain units of vinylidene fluoride, the level is preferably 2 to 30 (most preferably between 10 and 20) weight percent. Generally, the lower the level of vinylidene fluoride, the better the fluoroelastomer's resistance to alkaline fluids (also referred to as “base resistance” in the art). However, copolymers of TFE and P containing no vinylidene fluoride units generally have less resistance to hydrocarbon fluids such as oils or fuels than do copolymers that contain VF₂. The addition of VF₂ to the fluoroelastomer increases the polarity of the copolymer and thus improves the resistance to hydrocarbons, but at the same time reduces the resistance of the fluoroelastomer to polar fluids. Depending upon the end use application environment, fluoroelastomer base resistance and hydrocarbon fluid resistance can be balanced by adjusting the level of copolymerized vinylidene fluoride and tetrafluoroethylene in the fluoroelastomer.

The fluoroelastomers employed in this invention are generally prepared by free radical emulsion or suspension polymerization. Preferably, the polymerizations are carried out in batch, or semi-batch emulsion processes well known in the art (U.S. Pat. No. 6,703,450 B2). The resulting fluoroelastomer latexes are usually coagulated by addition of electrolytes. The precipitated polymer is washed with water and then dried, for example in an air oven, to produce a substantially dry fluoroelastomer gum.

Curable compositions of this invention contain A) a fluoroelastomer, as defined above, B) a polyhydroxy curative, C) an acid acceptor and D) at least one vulcanization (or curing) accelerator of formula R₁R₂R₃R₄NBF₄ wherein R₁, R₂, R₃, R₄ are the same or different C₁-C₁₂ alkyl groups.

In the case of fluoroelastomers which also contain optional bromine or iodine atom cure sites, the curable compositions of this invention may, optionally, also contain an organic peroxide and a multifunctional curing coagent. Cured articles resulting from the latter compositions contain crosslinks due to both the polyhydroxy and peroxide curing systems and are sometimes referred to in the art as dual cured elastomers.

The curable compositions of the invention contain between 0.1 to 20 parts by weight (preferably 1-5 parts) of polyhydroxy crosslinking agent (including derivatives thereof and salts) per 100 parts by weight fluoroelastomer. Typical polyhydroxy cross-linking agents include di-, tri-, and tetrahydroxybenzenes, naphthalenes, and anthracenes, and bisphenols of the formula

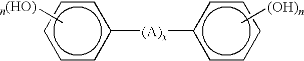

where A is a difunctional aliphatic, cycloaliphatic, or aromatic radical of 1-13 carbon atoms, or a thio, oxy, carbonyl, sulfinyl, or sulfonyl radical; A may optionally be substituted with at least one chlorine or fluorine atom; x is 0 or 1; n is 1 or 2; and any aromatic ring of the polyhydroxylic compound may optionally be substituted with at least one chlorine or fluorine atom, an amino group, a —CHO group, or a carboxyl or acyl radical. Preferred polyhydroxy compounds include hexafluoroisopropylidene-bis(4-hydroxy-benzene) (i.e. “bisphenol AF” or “BPAF”); 4,4′-isopropylidene diphenol (i.e. “bisphenol A”); 4,4′-dihydroxydiphenyl sulfone; and 2,2-bis[3-amino-4-hydroxyphenyl]hexafluoropropane (i.e. “diaminobisphenol AF or “DABPAF”). Referring to the bisphenol formula shown above, when A is alkylene, it can be for example methylene, ethylene, chloroethylene, fluoroethylene, difluoroethylene, propylidene, isopropylidene, tributylidene, heptachlorobutylidene, hepta-fluorobutylidene, pentylidene, hexylidene, and 1,1-cyclohexylidene. When A is a cycloalkylene radical, it can be for example 1,4-cyclohexylene, 2-chloro-1,4-cyclohexylene, cyclopentylene, or 2-fluoro-1,4-cyclohexylene. Further, A can be an arylene radical such as m-phenylene, p-phenylene, o-phenylene, methylphenylene, dimethylphenylene, 1,4-naphthylene, 3-fluoro-1,4-naphthylene, and 2,6-naphthylene. Polyhydroxyphenols of the formula

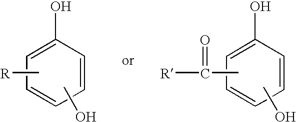

where R is H or an alkyl group having 1-4 carbon atoms or an aryl group containing 6-10 carbon atoms and R′ is an alkyl group containing 1-4 carbon atoms also act as effective crosslinking agents. Examples of such compounds include hydroquinone, catechol, resorcinol, 2-methylresorcinol, 5-methyl-resorcinol, 2-methylhydroquinone, 2,5-dimethylhydroquinone, 2-t-butyl-hydroquinone, 2,4-dihydroxybenzophenone; and such compounds as 1,5-dihydroxynaphthalene and 2,6-dihydroxynaphthalene.

Additional polyhydroxy curing agents include alkali metal salts of bisphenol anions, quaternary ammonium salts of bisphenol anions, tertiary sulfonium salts of bisphenol anions and quaternary phosphonium salts of bisphenol anions, e.g. the salts of bisphenol A and bisphenol AF. Specific examples include the disodium salt of bisphenol AF, the dipotassium salt of bisphenol AF, the monosodium monopotassium salt of bisphenol AF, the benzyltriphenylphosphonium salt of bisphenol AF, the methyltributylammonium salt of bisphenol AF and the tetrabutylammonium salt of bisphenol AF.

Quaternary ammonium and phosphonium salts of bisphenol anions are discussed in U.S. Pat. Nos. 4,957,975 and 5,648,429. Bisphenol AF salts (1:1 molar ratio) with quaternary ammonium ions of the formula R₁R₂R₃R₄N⁺, wherein R₁-R₄ are C₁-C₈ alkyl groups and at least three of R₁-R₄ are C₃ or C₄ alkyl groups are preferred. Specific examples of these preferred compositions include the 1:1 molar ratio salts of tetrapropyl ammonium-, methyltributylammonium- and tetrabutylammonium bisphenol AF. Such salts may be made by a variety of methods. For instance a methanolic solution of bisphenol AF may be mixed with a methanolic solution of a quaternary ammonium salt, the pH is then raised with sodium methoxide, causing an inorganic sodium salt to precipitate. After filtration, the tetraalkylammonium/BPAF salt may be isolated from solution by evaporation of the methanol. Alternatively, a methanolic solution of tetraalkylammonium hydroxide may be employed in place of the solution of quaternary ammonium salt, thus eliminating the precipitation of an inorganic salt and the need for its removal prior to evaporation of the solution.

In addition, derivatized polyhydroxy compounds such as mono- or diesters, and trimethylsilyl ethers are useful crosslinking agents. Examples of such compositions include, but are not limited to resorcinol monobenzoate, the diacetate of bisphenol AF, the diacetate of sulfonyl diphenol, and the diacetate of hydroquinone.

The curable compositions of the invention also contain between 0.5 to 30 parts by weight (preferably 0.7 to 10 parts) of an acid acceptor per 100 parts by weight fluoroelastomer. The acid acceptor is typically a strong organic base such as Proton Sponge® (available from Aldrich) or an oxirane, or an inorganic base such as a metal oxide, metal hydroxide, or a mixture of 2 or more of the latter. Metal oxides or hydroxides which are useful acid acceptors include calcium hydroxide, magnesium oxide, lead oxide, zinc oxide and calcium oxide. Calcium hydroxide and magnesium oxide are preferred.

Curable compositions of the invention contain 0.1 to 10 (preferably 0.5 to 3) parts by weight per 100 parts by weight fluoroelastomer of a vulcanization (or “cure”) accelerator of formula R₁R₂R₃R₄NBF₄ wherein R₁, R₂, R₃, R₄ are the same or different C₁-C₁₂ alkyl groups. Specific accelerators include, but are not limited to methyltributylammonium tetrafluoroborate, tetrapropylammonium tetrafluoroborate, methyltripropylammonium tetrafluoroborate, octyltrimethylammonium tetrafluoroborate and tetrabutylammonium tetrafluoroborate. Tetrabutylammonium tetrafluoroborate is preferred.

Optionally, one or more vulcanization accelerators in addition to the above tetrafluoroborate salt may be employed in the curable compositions of the invention. These optional accelerators include tertiary sulfonium salts such as [(C₆H₅)₂S⁺(C₆H₁₃)][Cl]⁻, and [(C₆H₁₃)₂S(C₆H₅)]⁺[CH₃CO₂]⁻ and quaternary ammonium, phosphonium, and stibonium salts of the formula R₅R₆R₇R₈Y⁺ X⁻ where Y is phosphorous, nitrogen, or antimony; R₅, R₆, R₇, and R₈ are individually C₁-C₂₀ alkyl, aryl, aralkyl, alkenyl, and the chlorine, fluorine, bromine, cyano, —OR, and —COOR substituted analogs thereof, with R being C₁-C₂₀ alkyl, aryl, aralkyl, alkenyl, and where X is halide, hydroxide, sulfate, sulfite, carbonate, pentachlorothiophenolate, hexafluorosilicate, hexafluorophosphate, dimethyl phosphate, and C₁-C₂₀ alkyl, aryl, aralkyl, and alkenyl carboxylates and dicarboxylates. Particularly preferred are benzyltriphenylphosphonium chloride, benzyltriphenylphosphonium bromide, tetrabutylammonium hydrogen sulfate, tetrabutylammonium hydroxide, tetrapropylammonium hydroxide, tetrabutylammonium bromide, tributylallylphosphonium chloride, tributyl-2-methoxypropylphosphonium chloride, 1,8-diazabicyclo[5.4.0]undec-7-ene, and benzyldiphenyl(dimethylamino) phosphonium chloride. Other useful accelerators include methyltrioctylammonium chloride, methyltributylammonium chloride, tetrapropylammonium chloride, benzyltrioctylphosphonium bromide, benzyltrioctylphosphonium chloride, methyltrioctylphosphonium acetate, tetraoctylphosphonium bromide, methyltriphenylarsonium tetrafluoroborate, tetraphenylstibonium bromide, 4-chlorobenzyltriphenyl phosphonium chloride, 8-benzyl-1,8-diazabicyclo(5.4.0)-7-undecenonium chloride, diphenylmethyltriphenylphosphonium chloride, allyltriphenyl-phosphonium chloride, tetrabutylphosphonium bromide, m-trifluoromethyl-benzyltrioctylphosphonium chloride, and other quaternary compounds disclosed in U.S. Pat. Nos. 5,591,804; 4,912,171; 4,882,390; 4,259,463; 4,250,278 and 3,876,654. The amount of optional, additional accelerator that may be employed in the composition of the invention is between 0.1 and 20 parts (preferably 0.5 to 3 parts) by weight per hundred parts by weight fluoroelastomer.

Preferably, the compositions of the invention exhibit less than a 15 point rise during 20 minutes at 121° C. in a Mooney Scorch test (ASTM D1646) while having a relatively fast cure time (tc50<5 minutes) in a Moving Disc Rheometer test (ASTM D5289) at the desired cure temperature, typically between 150° and 200° C.

Optionally, the curable compositions of the invention that contain a fluoroelastomer having bromine or iodine cure sites may contain a second curing agent in the form of a combination of an organic peroxide and a multifunctional (i.e. polyunsaturated) coagent compound. Examples of organic peroxides which are particularly effective curing agents for fluoroelastomers include dialkyl peroxides or bis(dialkyl peroxides) which decompose at a temperature above 50° C. In many cases one will prefer to use a di-t-butylperoxide having a tertiary carbon atom attached to a peroxy oxygen. Among the most useful are 2,5-dimethyl-2,5-di(t-butylperoxy)hexyne-3 and 2,5-dimethyl-2,5-di(t-butyl-peroxy)hexane. Other peroxides can be selected from such compounds as dicumyl peroxide, dibenzoyl peroxide, t-butyl perbenzoate, and di[1,3-dimethyl-3-(t-butyl-peroxy)butyl]carbonate. Multifunctional coagents which cooperate with such peroxides to provide curing systems include methacrylates, allyl compounds, divinyl compounds, and polybutadienes. Specific examples of coagents include one or more of the following compounds: triallyl cyanurate; triallyl isocyanurate; tris(diallylamine-s-triazine); triallyl phosphite; hexaallyl phosphoramide, N,N-diallyl acrylamide; N,N,N′N′-tetraallyl terephthalamide; N,N,N′,N′-tetraallyl malonamide; trivinyl isocyanurate; 2,4,6-trivinylmethyltrisiloxane; and tri(5-norbornene-2-methylene)cyanurate. If a peroxide cure system is present in the compounds of the invention, the organic peroxide is generally at a level between 0.2 to 7 parts by weight (preferably 1 to 3 parts) per 100 parts by weight fluoroelastomer and the coagent is present at a level of 0.1 to 10 (preferably 1 to 5) parts by weight per 100 parts by weight fluoroelastomer.

The curable composition of the invention may contain other additives, commonly used in elastomer compounding and processing. The latter may be introduced into the composition before addition of the curative, simultaneously with it, or following the addition. Typical additives include fillers, plasticizers, processing aids, antioxidants, pigments, and the like. The amount of such ingredients which is added will depend on the particular end use applications for which the cured compositions are adapted. Fillers, such as carbon black, clays, barium sulfate, calcium carbonate, magnesium silicate, and fluoropolymers are generally added in amounts of from 5-100 parts by weight per 100 parts by weight fluoroelastomer. The amount of plasticizer used is generally from 0.5-5.0 parts by weight per 100 parts by weight fluoroelastomer. Typical plasticizers include esters, such as dioctyl phthalate and dibutyl sebacate. Processing aids are generally used in amounts of from 0.1-2.0 parts by weight per 100 parts by weight fluoroelastomer. Suitable processing aids include tetramethylene sulfone, p-chlorophenyl sulfone, and waxes, for example, carnauba wax, that aid in the processing of the compositions.

The fluoroelastomer, polyhydroxy curative, acid acceptor, accelerator and any other ingredients are generally incorporated into the curable compositions of the invention by means of an internal mixer or rubber mill. The resulting composition may then be shaped (e.g. molded or extruded) and cured. Curing typically takes place at about 150°-200° C. for 1 to 60 minutes. Conventional rubber curing presses, molds, extruders, and the like provided with suitable heating and curing means can be used. Also, for optimum physical properties and dimensional stability, it is preferred to carry out a post curing operation wherein the molded or extruded article is heated in an oven or the like for an additional period of about 1-48 hours, typically from about 180°-275° C., generally in an air atmosphere.

The curable compositions of the invention result in cured fluoroelastomer articles which have unusually good base resistance, tensile properties and compression set resistance. Such articles find application as gaskets, seals and tubing, particularly in automotive end uses.

The invention is now illustrated by the following embodiments in which all parts are by weight unless otherwise indicated.

### EXAMPLES

### Test Methods

Physical properties of the compositions described in the examples were measured according to the following test procedures.

| | |
|---|---|
| Mooney Scorch | ASTM D1646 |
| Moving Disc Rheometer (MDR) | ASTM D5289 |
| Compression Set-B | ASTM D395 |

### Example 1

A curable composition of the invention (Sample 1) was made by mixing fluoroelastomer 1 (a copolymer containing 76.1 wt. % tetrafluoroethylene (TFE), 19.7 wt. % propylene (P), 4.2 wt. % 3,3,3-trifluoropropene (TFP) and having a ML (1+10) @121° C. of 32.4) with a polyhydroxy curative (bisphenol AF), acid acceptor (MgO and Ca(OH)₂), vulcanization accelerator (tetrabutylammonium tetrafluoroborate) and other ingredients on a conventional two-roll rubber mill, using standard mixing techniques employed in the elastomer industry. Comparative curable compositions (A, B and C) were made by the same procedure except that a vulcanization accelerator not having a tetrafluoroborate anion was used. The formulations are shown in Table I.

Curing characteristics were measured by MDR (at 177° C., 3° arc 24 minutes) and Mooney Scorch (121° C., 30 minutes, time to an 18 point rise) according to the Test Methods. The results are also shown in Table I. Sample 1 of the invention has a long Mooney scorch time (no rise in Mooney during 31 minutes), thus allowing ample time for mixing and shaping prior to the onset of significant crosslinking. Also Sample 1 displayed a moderately fast cure rate (tc50 of 3.29 minutes).

TABLE I

| | | Comp. | Comp. | Comp. |
|---|---|---|---|---|
| | Sample 1 | Sample A | Sample B | Sample C |
| Ingredient, phr¹ | | | | |
| Fluoroelastomer 1 | 100 | 100 | 100 | 100 |
| Tetrabutylammonium | 0 | 1.5 | 0 | 0 |
| hydrogen sulfate | | | | |
| Tetraethylammonium | 0 | 0.35 | 0 | |
| acetate•4H₂O | | | | |
| Tetrabutylammonium | 0 | 0 | 1.78 | |
| acetate | | | | |
| Tetrabutylammonium | 1.94 | 0 | 0 | 0 |
| tetrafluoroborate | | | | |
| Tetrapropylammonium | 0 | 0 | 0 | 1.67 |
| hydrogen sulfate | | | | |
| Bisphenol AF | 2 | 2 | 2 | 2 |
| Elastomag 170² | 3 | 3 | 3 | 3 |
| Calcium hydroxide | 6 | 6 | 6 | 6 |
| MT carbon black | 30 | 30 | 30 | 30 |
| Curing Characteristics | | | | |
| S′ₘᵢₙ, dN · m | 0.81 | 0.89 | 2.14 | 0.84 |
| S′ₘₐₓ, dN · m | 18.13 | 20.58 | 19.14 | 19.35 |
| tₛ2, minutes | 2.7 | 1.33 | 0.47 | 3.05 |
| tc50, minutes | 3.29 | 1.99 | 0.72 | 4.61 |
| tc90, minutes | 10.7 | 5.95 | 6.21 | 9.14 |
| Mooney Scorch, time | No rise | 17.45 | 5.50 | 21.7 |
| to an 18 point rise, | | | | |
| min. | | | | |

¹phr is parts by weight per 100 parts by weight rubber (i.e. elastomer)
²Magnesium oxide available from Morton Performance Chemicals, Inc.

### Example 2

Curable compositions of the invention (Samples 2-3) were made by mixing fluoroelastomer 2 (a copolymer containing 77 wt. % TFE, 17.7 wt. % P, 4 wt. % TFP and 1.3 wt. % 4-bromo-3,3,4,4-tetrafluorobutene-1 (BTFB) having an ML(1+10) @121° C. of 36) with polyhydroxy curative (both bisphenol AF and the methyltributyl ammonium bisphenol AF salt), acid acceptor (MgO), vulcanization accelerator (tetrabutylammonium tetrafluoroborate) and other ingredients on a conventional two-roll rubber mill, using standard mixing techniques employed in the elastomer industry. Comparative curable composition D was made by the same procedure except that a vulcanization accelerator not having a tetrafluoroborate anion was used. The formulations are shown in Table II.

Curing characteristics were measured by MDR (at 175° C., 0.5° arc 20 minutes) and Mooney Scorch (121° C., 30 minutes, time to a 15 point rise) according to the Test Methods. Tensile properties of cured slabs and compression set of cured o-rings (both slabs and o-rings press cured for 10 minutes @177° C. and then post cured in an air oven for 16 hours at 200° C.) were measured according to the Test Methods. The results are also shown in Table II.

TABLE II

| | | | Comp. |
|---|---|---|---|
| | Sample 2 | Sample 3 | Sample D |
| Ingredient, phr¹ | | | |
| Fluoroelastomer 2 | 100 | 100 | 100 |
| MTBABPAF³ | 2.0 | 1.5 | 2.5 |
| Tetrabutylammonium | 0.3 | 0.9 | 0 |
| tetrafluoroborate | | | |
| Bisphenol AF | 0.3 | 0.6 | 0 |
| Elastomag 170 | 8 | 8 | 8 |
| MT Carbon Black | 30 | 30 | 30 |
| Curing Characteristics | | | |
| M_{L}, dN · m | 1.3 | 1.2 | 1.8 |
| M_{H}, dN · m | 19.3 | 18.6 | 17.2 |
| tₛ2, minutes | 1.1 | 1.4 | 0.6 |
| tc50, minutes | 2.2 | 2.9 | 1.3 |
| tc90, minutes | 4.5 | 6.1 | 3.6 |
| Mooney Scorch, time | 17.3 | 27.0 | 5.4 |
| to 15 point rise, min. | | | |
| Tensile Properties | | | |
| M100, MPa | 8.1 | 6.9 | 8.6 |
| T_{B}, MPa | 13.9 | 12.5 | 14.4 |
| E_{B}, % | 205 | 249 | 181 |
| Hardness, Shore A | 77 | 76 | 76 |
| Compression Set | | | |
| Aged 168 hours | 20 | 20 | 23 |
| @150° C., % | | | |

³salt (1:1 molar ratio) of bisphenol AF curative and methyltributylammonium hydroxide accelerator

### Example 3

Curable compositions of the invention (Samples 4 and 5) were made by mixing fluoroelastomer 3 (a copolymer containing 77.1 wt. % TFE, 18.5 wt. % P, 4.4 wt. % TFP and having a ML (1+10) @121° C. of 38.7) with a polyhydroxy curative (bisphenol AF or methyltributylammonium bisphenol AF salt), acid acceptor (MgO and Ca(OH)₂), vulcanization accelerator (tetrabutylammonium tetrafluoroborate) and other ingredients on a conventional two-roll rubber mill, using standard mixing techniques employed in the elastomer industry. Comparative curable compositions (E and F) were made by the same procedure except that a vulcanization accelerator not having a tetrafluoroborate anion was used. The formulations are shown in Table III.

Curing characteristics were measured by MDR (at 177° C., 3° arc 24 minutes) and Mooney Scorch (121° C., 30 minutes, time to an 18 point rise) according to the Test Methods. The results are also shown in Table III. Samples 4 and 5 of the invention had long Mooney scorch times, 27.6 minutes (Sample 4), and no rise in Mooney during 31 minutes (Sample 5), thus allowing ample time for mixing and shaping prior to the onset of significant crosslinking. Also Samples 4 and 5 displayed moderately fast cure rates (tc50 of 1.91 and 3.05 minutes, respectively).

TABLE III

| | | Comp. | | Comp. |
|---|---|---|---|---|
| | Sample 4 | Sample E | Sample 5 | Sample F |
| Ingredient, phr¹ | | | | |
| Fluoroelastomer 3 | 100 | 100 | 100 | 100 |
| Tetrabutylammonium | 0 | 0.62 | 0 | 1.89 |
| hydrogen sulfate | | | | |
| Tetrabutylammonium | 0.60 | 0 | 1.83 | 0 |
| tetrafluoroborate | | | | |
| Bisphenol AF | 0 | 0 | 1.26 | 1.26 |
| MTBABPAF³ | 2.0 | 2.0 | 0 | 0 |
| Elastomag 170² | 8 | 8 | 8 | 8 |
| Calcium hydroxide | 2 | 2 | 2 | 2 |
| MT carbon black | 30 | 30 | 30 | 30 |
| Curing Characteristics | | | | |
| S′ₘᵢₙ, dN · m | 0.85 | 0.93 | 0.84 | 0.79 |
| S′ₘₐₓ, dN · m | 11.49 | 12.84 | 10.75 | 13.94 |
| tₛ2, minutes | 1.45 | 0.77 | 2.61 | 1.56 |
| tc50, minutes | 1.91 | 1.02 | 3.05 | 2.11 |
| tc90, minutes | 10.38 | 9.14 | 9.45 | 12.46 |
| Mooney Scorch, time | 27.6 | 5.9 | No rise | 8.8 |
| to an 18 point rise, | | | | |
| min. | | | | |

What is claimed is:

1. A curable fluoroelastomer composition comprising
A) a fluoroelastomer comprising copolymerized units of 45 to 80 weight percent tetrafluoroethylene; 10 to 40 weight percent propylene; and 0.1 to 10 mole percent of a cure site monomer selected from the group consisting of i) trifluoroethylene, ii) 3,3,3-trifluoropropene-1, iii) 1,2,3,3,3-pentafluoropropylene, iv) 1,1,3,3,3-pentafluoropropylene, and v) 2,3,3,3-tetrafluoropropene;
B) 0.1 to 20 parts by weight per 100 parts by weight fluoroelastomer of a polyhydroxy curing agent;
C) 0.5 to 30 parts by weight per 100 parts by weight fluoroelastomer of an acid acceptor; and
D) 0.1 to 10 parts by weight per 100 parts by weight fluoroelastomer of at least one vulcanization accelerator of formula R₁R₂R₃R₄NBF₄ wherein R₁, R₂, R₃, R₄ are the same or different C₁-C₁₂ alkyl groups.

2. A curable fluoroelastomer composition of claim 1 wherein said fluoroelastomer comprises copolymerized units of tetrafluoroethylene present in an amount between 65 and 78 weight percent; copolymerized units of propylene in an amount between 15 and 25 weight percent; and copolymerized units of cure site monomer in an amount between 0.1 and 10 mole percent.

3. A curable fluoroelastomer composition of claim 1 wherein said cure site monomer is 3,3,3-trifluoropropene-1.

4. A curable fluoroelastomer composition of claim 1 wherein said fluoroelastomer further comprises copolymerized units of vinylidene fluoride present in an amount between 2 and 30 weight percent.

5. A curable fluoroelastomer composition of claim 1 wherein said fluoroelastomer further comprises up to 2 mole percent of bromine or iodine cure sites.

6. A curable fluoroelastomer composition of claim 5 further comprising E) 0.2 to 7 parts by weight per 100 parts by weight fluoroelastomer of an organic peroxide and F) 0.1 to 10 parts by weight per 100 parts by weight fluoroelastomer of a multifunctional coagent.

7. A curable fluoroelastomer composition of claim 1 wherein said polyhydroxy curing agent B is a curing agent selected from the group consisting of i) dihydroxy-, trihydroxy-, and tetrahydroxy- benzenes, -naphthalenes, and -anthracenes;
ii) bisphenols of the formula 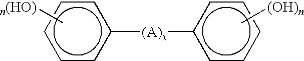
where A is a stable divalent radical; x is 0 or 1; and n is 1 or 2;
iii) dialkali salts of said bisphenols; iv) quaternary ammonium salts of said bisphenols; v) quaternary phosphonium salts of said bisphenols; vi) tertiary sulfonium salts of said bisphenols; vii) esters of said bisphenols; and viii) 2,2-bis[3-amino-4-hydroxyphenyl]hexafluoropropane.

8. A curable fluoroelastomer composition of claim 1 wherein said vulcanization accelerator D is selected from the group consisting of methyltributylammonium tetrafluoroborate, tetrapropylammonium tetrafluoroborate, methyltripropylammonium tetrafluoroborate, octyltrimethylammonium tetrafluoroborate and tetrabutylammonium tetrafluoroborate.

9. A curable fluoroelastomer composition of claim 8 wherein said vulcanization accelerator D is tetrabutylammonium tetrafluoroborate.

10. A curable fluoroelastomer composition of claim 1 further comprising a second vulcanization accelerator different from vulcanization accelerator D.
